(19) United States
(12) Patent Application Publication
(10) Pub. No.: US 2022/0338064 A1
(43) Pub. Date: Oct. 20, 2022

(54) WIRELESS COMMUNICATION DEVICE, NON-TRANSITORY COMPUTER READABLE STORAGE MEDIUM, AND SYSTEM

(71) Applicant: KABUSHIKI KAISHA TOKAI RIKA DENKI SEISAKUSHO, Aichi (JP)

(72) Inventors: Yosuke Hasegawa, Aichi (JP); Yosuke Ohashi, Aichi (JP)

(73) Assignee: KABUSHIKI KAISHA TOKAI RIKA DENKI SEISAKUSHO, Aichi (JP)

(21) Appl. No.: 17/697,367

(22) Filed: Mar. 17, 2022

(30) Foreign Application Priority Data
Apr. 16, 2021 (JP) 2021-069847

(51) Int. Cl. H04W 28/18; H04W 64/00; H04W 12/06

(52) U.S. Cl. CPC H04W 28/18; H04W 64/006; H04W 12/06; H04W 88/06

(57) ABSTRACT

There is provided a wireless communication device, comprising: a first wireless communication unit configured to transmit and receive a wireless signal compliant with a first communication standard to and from another wireless communication device different from the wireless communication device; at least one second wireless communication unit configured to transmit and receive a wireless signal compliant with a second communication standard different from the first communication standard to and from the other wireless communication device; and a control unit configured to control transmission and reception of wireless signals, wherein, in a case where authentication based on the wireless signal compliant with the first communication standard is established and specified processing based on the wireless signal compliant with the second communication standard is not established, the control unit performs control so that the authentication is not re-executed and the specified processing is re-executed.

### CROSS REFERENCE TO RELATED APPLICATION(S)

This application is based upon and claims benefit of priority from Japanese Patent Application No. 2021-069847, filed on Apr. 16, 2021, the entire contents of which are incorporated herein by reference.

### BACKGROUND

The present invention relates to a wireless communication device, a non-transitory computer readable storage medium, and a system.

In recent years, a technique of performing authentication in accordance with the result of transmitting and receiving signals between devices has been developed. For example, JP H11-208419A discloses a system in which a vehicle-mounted device authenticates a portable device by transmitting and receiving a signal to and from the portable device.

### SUMMARY

In the above system, in order to improve security, a multi-stage mechanism of authentication is also envisaged. However, in such a configuration, a time required for re-execution of processing is likely to increase.

Consequently, the present invention was contrived in view of the above problem, and an object of the present invention is to improve responsiveness while ensuring security in authentication between devices.

To solve the above described problem, according to an aspect of the present invention, there is provided a wireless communication device, comprising: a first wireless communication unit configured to transmit and receive a wireless signal compliant with a first communication standard to and from another wireless communication device different from the wireless communication device; at least one second wireless communication unit configured to transmit and receive a wireless signal compliant with a second communication standard different from the first communication standard to and from the other wireless communication device; and a control unit configured to control transmission and reception of wireless signals performed by the first wireless communication unit and the second wireless communication unit, wherein, in a case where authentication based on the wireless signal compliant with the first communication standard is established and specified processing based on the wireless signal compliant with the second communication standard is not established, the control unit performs control so that the authentication is not re-executed and the specified processing is re-executed.

To solve the above described problem, according to another aspect of the present invention, there is provided a non-transitory computer readable storage medium having a program stored therein, the program causing a computer to realize a control function of controlling a first wireless communication unit configured to transmit and receive a wireless signal compliant with a first communication standard to and from another wireless communication device and at least one second wireless communication unit configured to transmit and receive a wireless signal compliant with a second communication standard different from the first communication standard to and from the other wireless communication device, wherein, in a case where authentication based on the wireless signal compliant with the first communication standard is established and specified processing based on the wireless signal compliant with the second communication standard is not established, the control function is caused to perform control so that the authentication is not re-executed and the specified processing is re-executed.

To solve the above described problem, according to another aspect of the present invention, there is provided a system comprising: a first wireless communication device; and a second wireless communication device, wherein the first wireless communication device includes a first wireless communication unit configured to transmit and receive a wireless signal compliant with a first communication standard to and from the second wireless communication device, at least one second wireless communication unit configured to transmit and receive a wireless signal compliant with a second communication standard different from the first communication standard to and from the second wireless communication device, and a control unit configured to control transmission and reception of wireless signals performed by the first wireless communication unit and the second wireless communication unit, wherein, in a case where authentication based on the wireless signal compliant with the first communication standard is established and specified processing based on the wireless signal compliant with the second communication standard is not established, the control unit performs control so that the authentication is not re-executed and the specified processing is re-executed.

As described above, according to the present invention, it is possible to improve responsiveness while ensuring security in authentication between devices.

### BRIEF DESCRIPTION OF THE DRAWINGS

FIG. 1 is a block diagram illustrating a configuration example of a system 1 according to an embodiment of the present invention.

FIG. 2 is a sequence diagram illustrating an example of a flow of authentication based on a wireless signal compliant with a first communication standard according to the embodiment and specified processing based on a wireless signal compliant with a second communication standard.

FIG. 3 is a sequence diagram illustrating an example of a flow of re-execution control of specified processing according to the embodiment.

FIG. 4 is a flowchart illustrating an example of a flow of control performed by a control unit 130 of a vehicle-mounted device 10 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment>

### 1.1. System Configuration Example

First, a configuration example of a system 1 according to an embodiment of the present invention will be described.

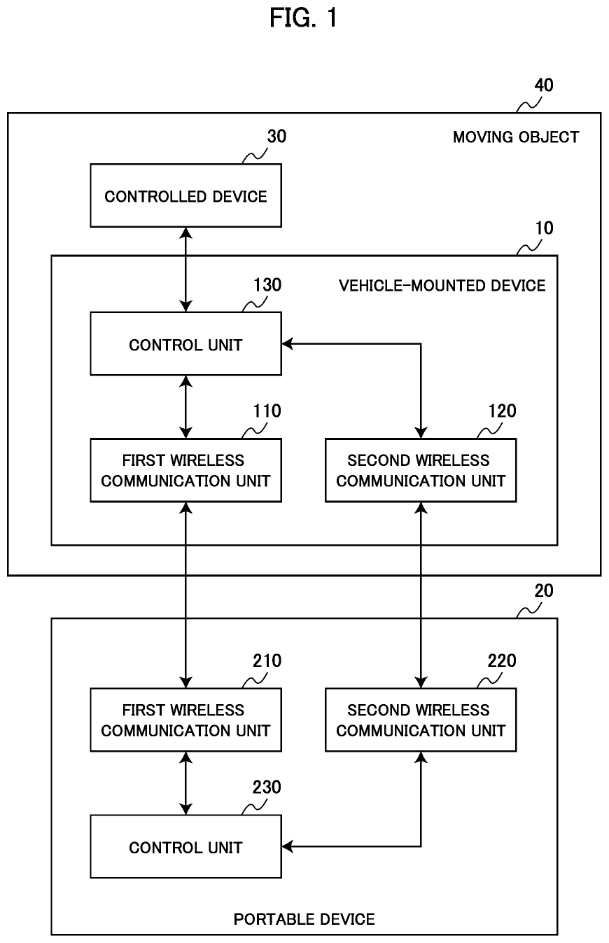

FIG. 1 is a block diagram illustrating a configuration example of the system 1 according to an embodiment of the present invention.

In the case of the example shown in FIG. 1, the system 1 according to the present embodiment includes a vehicle-mounted device 10 and a controlled device 30 which are mounted in a moving object 40 such as a vehicle and a portable device 20.

### (Vehicle-Mounted Device 10)

The vehicle-mounted device 10 according to the present embodiment is an example of a wireless communication device mounted in the moving object 40 to perform wireless communication with another wireless communication device (the portable device 20).

As shown in FIG. 1, the vehicle-mounted device 10 according to the present embodiment may include a first wireless communication unit 110, a second wireless communication unit 120, and a control unit 130.

### (First Wireless Communication Unit 110)

The first wireless communication unit 110 according to the present embodiment transmits and receives a wireless signal compliant with a first wireless communication standard to and from the portable device 20 carried by a user who uses the moving object 40 in which the vehicle-mounted device 10 is mounted (for example, an owner of the moving object 40 or a person who is permitted to use the moving object 40 by the owner).

For example, a signal in a low frequency (LF) band and a signal in an ultra-high frequency (UHF) band may be used in the first wireless communication standard.

The first wireless communication unit 110 includes an antenna element for transmitting and receiving a wireless signal compliant with the first wireless communication standard.

In addition, the first wireless communication unit 110 according to the present embodiment may authenticate the portable device 20 on the basis of the transmitted and received wireless signal.

As an example, the first wireless communication unit 110 according to the present embodiment transmits an authentication request to the portable device 20 in accordance with control performed by the control unit 130, and receives an authentication response which is transmitted by the portable device 20 as a response to the authentication request.

In this case, the authentication request may be a signal for requesting information required for authentication relating to the authenticity of the portable device 20, and the authentication request may be a signal including information required for authentication.

Meanwhile, examples of the information required for the authentication include an identifier of the portable device 20, a password determined in advance, key information, a result of calculation using a hash function, and the like.

The first wireless communication unit 110 transmits the result of authentication to the control unit 130.

On the other hand, authentication based on the authentication request and the authentication response may be executed by the control unit 130.

### (Second Wireless Communication Unit 120)

The second wireless communication unit 120 according to the present embodiment transmits and receives a wireless signal compliant with a second wireless communication standard different from the first wireless communication standard to and from the portable device 20.

Meanwhile, the vehicle-mounted device 10 according to the present embodiment includes at least one second wireless communication unit 120.

In addition, an example of the second wireless communication standard is ultra-wide band (UWB) wireless communication.

On the other hand, the second wireless communication standard according to the present embodiment is not limited to the above example, and may be any of various standards that can be used to execute specified processing to be described later.

The second wireless communication unit 120 includes an antenna element for transmitting and receiving a wireless signal compliant with the second wireless communication standard.

In addition, the second wireless communication unit 120 according to the present embodiment may execute specified processing using the transmitted and received wireless signal.

The specified processing may be, for example, processing of estimating a positional relationship between the vehicle-mounted device 10 and the portable device 20 (more accurately, a positional relationship between the second wireless communication unit 120 and a second wireless communication unit 220 provided in the portable device 20).

Examples of the processing of estimating the positional relationship include processing of estimating a distance between the vehicle-mounted device 10 and the portable device 20 (hereinafter also referred to as distance measurement) and processing of estimating the angle of the portable device 20 with the vehicle-mounted device 10 as a starting point.

In addition, the processing of estimating the positional relationship may be processing of estimating the position coordinates of the portable device 20 on the basis of the results of a plurality of distance measurements performed by a plurality of second wireless communication units 120.

In addition, the second wireless communication unit 120 transmits the result of the specified processing to the control unit 130.

### (Control Unit 130)

The control unit 130 according to the present embodiment controls the transmission and reception of wireless signals performed by the first wireless communication unit 110 and the second wireless communication unit 120.

In addition, the control unit 130 according to the present embodiment controls the operation of the controlled device 30 mounted in the moving object 40 on the basis of the result of authentication using a wireless signal compliant with the first communication standard and the result of specified processing using a wireless signal compliant with the second communication standard.

For example, in a case where the authenticity of the portable device 20 is recognized on the basis of the authentication response and the specified processing is within a specified range, the control unit 130 according to the present embodiment may cause the controlled device 30 to execute a specified operation.

For example, in a case where the specified processing is processing of estimating the above-described positional relationship, the authenticity of the portable device 20 is recognized, and it is estimated that the vehicle-mounted device 10 and the portable device 20 are in a specified positional relationship, the control unit 130 may cause the controlled device 30 to execute a specified operation.

In addition, for example, in a case where the specified processing is the above-described distance measurement, the authenticity of the portable device 20 is recognized, and the estimation value of a distance between the vehicle-mounted device 10 and the portable device 20, that is, the distance measurement value obtained by the distance measurement, is estimated to be in a specified range, the control unit 130 may cause the controlled device 30 to execute a specified operation.

Meanwhile, the controlled device 30 according to the present embodiment may be any of various devices mounted in the moving object 40.

The controlled device 30 according to the present embodiment may be, for example, a locking device that controls unlocking and locking of the door of the moving object 40, an engine, or the like.

For example, in a case where the authenticity of the portable device 20 is recognized and the result of the specified processing satisfies specified conditions, the control unit 130 may cause the locking device to execute unlocking of the door or start the engine.

The function of the control unit 130 according to the present embodiment is realized by various processors.

### (Portable Device 20)

The portable device 20 according to the present embodiment is an example of a wireless communication device which is carried by a user who uses the moving object 40 to perform wireless communication with the vehicle-mounted device 10 mounted in the moving object 40.

As shown in FIG. 1, the portable device 20 according to the present embodiment may include a first wireless communication unit 210, the second wireless communication unit 220, and a control unit 230.

### (First Wireless Communication Unit 210)

The first wireless communication unit 210 according to the present embodiment transmits and receives a wireless signal compliant with the first wireless communication standard to and from the vehicle-mounted device 10 mounted in the moving object 40.

For this purpose, the first wireless communication unit 210 according to the present embodiment includes an antenna element capable of transmitting and receiving a wireless signal compliant with the first wireless communication standard.

A case where the first wireless communication unit 110 of the vehicle-mounted device 10 transmits an authentication request and the first wireless communication unit 210 of the portable device 20 transmits an authentication response as a response to the authentication request has been given as an example above.

On the other hand, in a case where the portable device 20 authenticates the vehicle-mounted device 10, the authentication request may be transmitted by the first wireless communication unit 210 of the portable device 20. In this case, the first wireless communication unit 110 of the vehicle-mounted device 10 transmits an authentication response as a response to the received authentication request.

### (Second Wireless Communication Unit 220)

The second wireless communication unit 220 according to the present embodiment transmits and receives a wireless signal compliant with the second wireless communication standard to and from the vehicle-mounted device 10 mounted in the moving object 40.

For this purpose, the second wireless communication unit 220 according to the present embodiment includes an antenna element capable of transmitting and receiving a wireless signal compliant with the second wireless communication standard.

In addition, the second wireless communication unit 220 according to the present embodiment may execute specified processing on the basis of the transmitted and received wireless signal.

### (Control Unit 230)

The control unit 230 according to the present embodiment controls the transmission and reception of wireless signals performed by the first wireless communication unit 210 and the second wireless communication unit 220.

The function of the control unit 130 according to the present embodiment is realized by various processors.

Heretofore, a configuration example of the system 1 according to the present embodiment has been described above. Meanwhile, the above configuration described with reference to FIG. 1 is merely an example, and the configuration of the system 1 according to the present embodiment is not limited to such an example.

For example, the vehicle-mounted device 10 may include a plurality of second wireless communication units 120. In this case, each of the plurality of second wireless communication units 120 may transmit and receive wireless communication to and from the portable device 20 and execute specified processing.

### 1.2. Details

Next, processing performed by the system 1 according to the present embodiment will be described in detail.

Here, first, the flow of processing in a case where the authentication based on a wireless signal compliant with the first communication standard and the specified processing based on a wireless signal compliant with the second communication standard are executed will be described.

Meanwhile, a case where the above-described specified processing is distance measurement will be illustrated below.

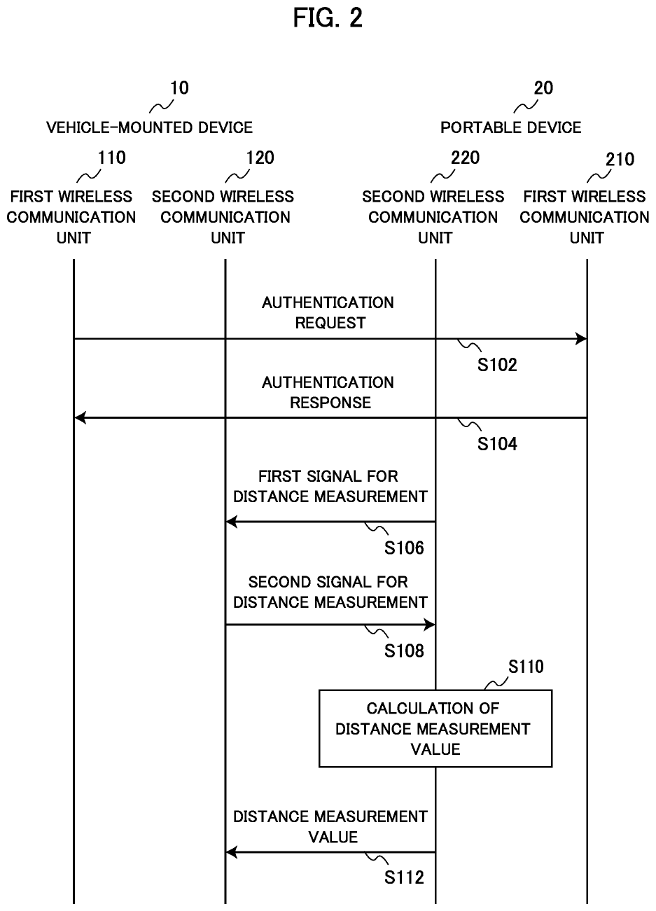

FIG. 2 is a sequence diagram illustrating an example of a flow of authentication based on the wireless signal compliant with the first communication standard according to the present embodiment and specified processing based on the wireless signal compliant with the second communication standard.

In the case of the example shown in FIG. 2, first, the control unit 130 of the vehicle-mounted device 10 causes the first wireless communication unit 110 to transmit an authentication request (S102).

The control unit 230 of the portable device 20 causes the first wireless communication unit 210 to transmit an authentication response as a response to the authentication request on the basis of the first wireless communication unit 210 receiving the authentication request in step S102 (S104).

In step S104, in a case where the first wireless communication unit 110 of the vehicle-mounted device 10 receives the authentication response, the first wireless communication unit 110 or the control unit 130 authenticates the portable device 20 on the basis of the authentication response (not shown).

On the other hand, the control unit 230 of the portable device 20 causes the first wireless communication unit 210 to transmit the authentication response in step S104, and then causes the second wireless communication unit 220 to transmit a first signal for distance measurement used for distance measurement (S106).

In step S106, in a case where the second wireless communication unit 120 of the vehicle-mounted device 10 receives the first signal for distance measurement, the control unit 130 causes the second wireless communication unit 120 to transmit a second signal for distance measurement in response to the first signal for distance measurement (S108).

Next, the second wireless communication unit 220 of the portable device 20 calculates the distance measurement value on the basis of the first signal for distance measurement transmitted in step S106 and the second signal for distance measurement received in step S108 (S110).

In this way, the distance measurement according to the present embodiment may include the transmission and reception of the first signal for distance measurement and the second signal for distance measurement and the calculation of the distance measurement value based on both signals.

The second wireless communication unit 220 of the portable device 20 can calculate the distance measurement value on the basis of a time ΔT1 from a time at which the first signal for distance measurement is transmitted to a time at which the second signal for distance measurement is received and a time ΔT2 from a time at which the second wireless communication unit 120 of the vehicle-mounted device 10 receives the first signal for distance measurement to a time at which the second signal for distance measurement is transmitted.

More specifically, the second wireless communication unit 220 of the portable device 20 can calculate a time for propagation of the first signal for distance measurement and the second signal for distance measurement (that is, a time required for round trip communication) by subtracting the time ΔT2 from the time ΔT1, and can calculate a time required for propagation of either the first signal for distance measurement or the second signal for distance measurement (that is, a time required for one-way communication) by dividing the time by two.

Further, the second wireless communication unit 220 can calculate the distance measurement value by multiplying the value of (time ΔT1−time ΔT2)/2 by the speed of the signal.

The second wireless communication unit 220 of the portable device 20 transmits the distance measurement value calculated as described above to the second wireless communication unit 120 of the vehicle-mounted device 10 (S112).

The control unit 130 of the vehicle-mounted device 10 controls the operation of the controlled device 30 on the basis of the result of authentication based on the distance measurement response received by the first wireless communication unit 110 in step S104 and the distance measurement value received by the second wireless communication unit 120 in step S112.

A flow of the authentication based on the wireless signal compliant with the first communication standard according to the present embodiment and the specified processing based on the wireless signal compliant with the second communication standard has been described above with an example.

Meanwhile, in the above description using FIG. 2, an example of the case where the first signal for distance measurement is transmitted by the second wireless communication unit 220 of the portable device 20 and the second signal for distance measurement is transmitted by the second wireless communication unit 120 of the vehicle-mounted device 10 has been described.

On the other hand, the first signal for distance measurement may be transmitted by the second wireless communication unit 120 of the vehicle-mounted device 10, and the second signal for distance measurement may be transmitted by the second wireless communication unit 220 of the portable device 20.

In addition, similarly, the calculation of the distance measurement value may be executed by either the second wireless communication unit 120 of the vehicle-mounted device 10 or the second wireless communication unit 220 of the portable device 20.

The calculation of the distance measurement value can be executed by either the second wireless communication unit 120 or the second wireless communication unit 220 by transmitting and receiving information relating to the time ΔT1 and the time ΔT2 described above.

Further, the transmission and reception of the first signal for distance measurement and the second signal for distance measurement and the calculation of the distance measurement value may be executed multiple times.

The flow of the distance measurement processing according to the present embodiment can be flexibly modified.

Next, re-execution control of the specified processing according to the present embodiment will be described.

In the above description using FIG. 2, an example in which the distance measurement that is an example of the specified processing is normally completed and the distance measurement value transmitted by the second wireless communication unit 220 of the portable device 20 is normally received by the second wireless communication unit 120 of the vehicle-mounted device 10 has been described.

However, it is also assumed that the first signal for distance measurement, the second signal for distance measurement, and the distance measurement value are not normally received by the other party's device due to the influence of noise or the like.

In this case, the control unit 130 of the vehicle-mounted device 10 may perform control so that specified processing such as distance measurement is re-executed.

However, at this time, in a case where the authentication that has been normally completed is re-executed, a time required for a series of processes will increase accordingly.

Therefore, in a case where the authentication based on the wireless signal compliant with the first communication standard is established and the specified processing based on the wireless signal compliant with the second communication standard is not established, the control unit 130 of the vehicle-mounted device 10 according to the present embodiment may perform control so that the authentication is not re-executed and the specified processing is re-executed.

According to the control as described above, it is possible to effectively reduce a time required for a series of processes while ensuring the normality of the operation control of the controlled device 30 by re-executing the specified processing that has not been established.

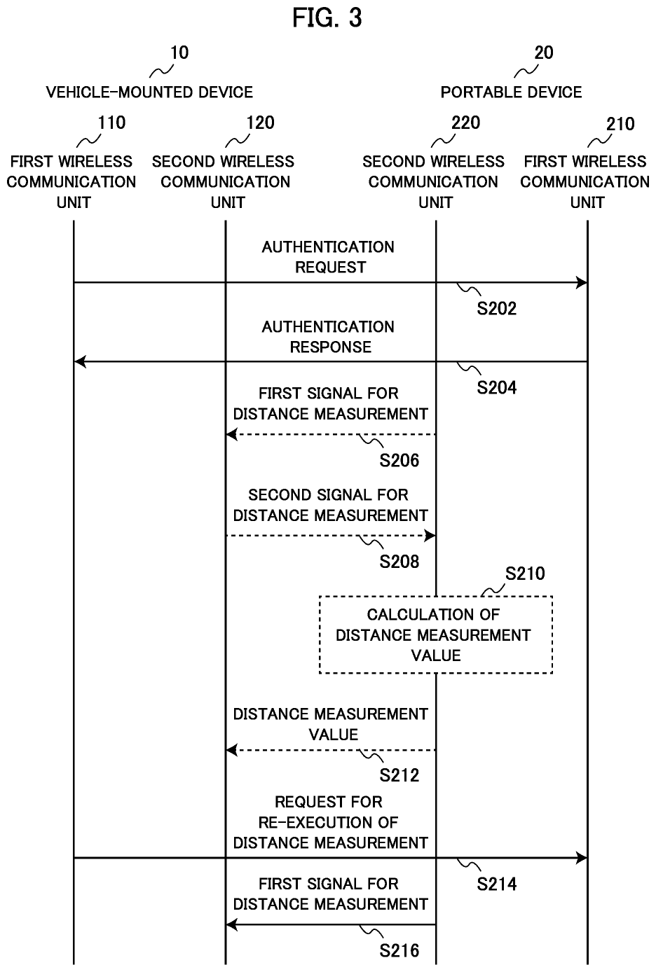

FIG. 3 is a sequence diagram illustrating an example of a flow of re-execution control of the specified processing according to the present embodiment.

Each process in steps S202 to S212 shown in FIG. 3 may be substantially the same as each process in S102 to S112 shown in FIG. 2, and thus the detailed description thereof will be omitted.

However, in an example shown in FIG. 3, it is assumed that some error occurs in the transmission and reception of the first signal for distance measurement in step S206, the transmission and reception of the second signal for distance measurement in step S208, the calculation of the distance measurement value in step S210, or the transmission of the distance measurement value in step S212, and the second wireless communication unit 120 of the vehicle-mounted device 10 cannot normally receive the distance measurement value.

In this way, in a case where the specified processing is not established, the control unit 130 of the vehicle-mounted device 10 according to the present embodiment may cause the first wireless communication unit 110 to transmit a request for re-execution of the specified processing using the wireless signal compliant with the first communication standard (S214).

In this case, the control unit 230 of the portable device 20 causes the second wireless communication unit 220 to retransmit the first signal for distance measurement on the basis of the first wireless communication unit 210 receiving the request for re-execution in step S214 (S216).

According to the control as described above, it is possible to re-execute distance measurement using the retransmitted first signal for distance measurement as a trigger, and to realize subsequent operation control of the controlled device 30.

Meanwhile, the control unit 130 may determine that the distance measurement is not established, for example, in a case where the first wireless communication unit 110 receives the authentication response and then the second wireless communication unit 120 cannot receive the distance measurement value within a specified time.

In addition, in the case of a sequence in which the second wireless communication unit 120 of the vehicle-mounted device 10 transmits the first signal for distance measurement, the control unit 130 may determine that the distance measurement is not established in a case where the second wireless communication unit 120 is caused to transmit the first signal for distance measurement and then the second wireless communication unit 120 cannot receive the second signal for distance measurement within a specified time.

Next, the flow of control performed by the control unit 130 of the vehicle-mounted device 10 will be described in more detail.

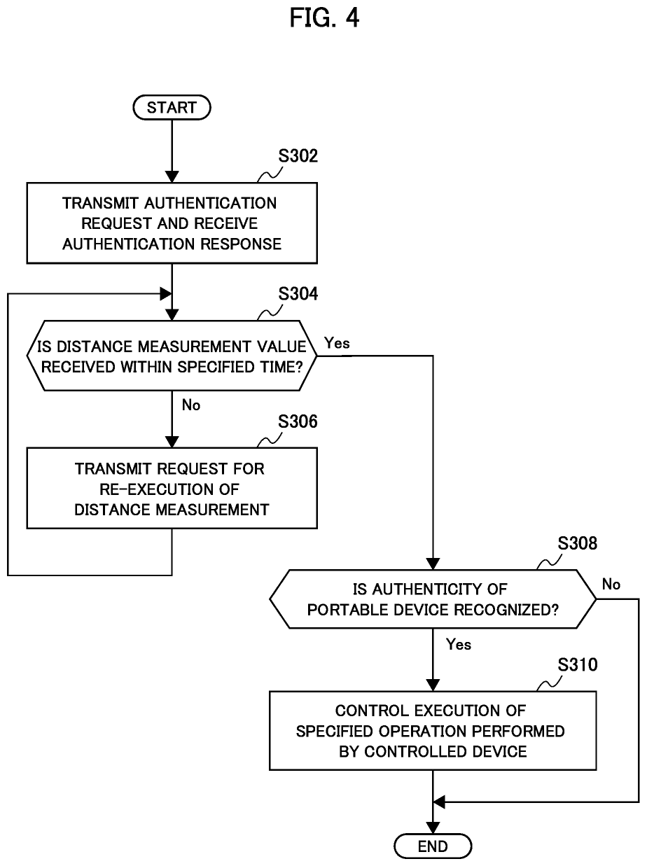

FIG. 4 is a flowchart illustrating an example of a flow of control performed by the control unit 130 of the vehicle-mounted device 10 according to the present embodiment.

Meanwhile, FIG. 4 shows an example of control in a case where the specified processing based on the wireless signal compliant with the second communication standard is distance measurement.

In addition, FIG. 4 shows an example of control in a case where the portable device 20 transmits the first signal for distance measurement.

In the case of the example shown in FIG. 4, the control unit 130 first causes the first wireless communication unit 110 to transmit an authentication request and receive an authentication response as a response to the authentication request (S302).

Here, it is assumed that the authenticity of the portable device 20 is recognized on the basis of the authentication response.

Next, the control unit 130 determines whether the first wireless communication unit 110 has received the authentication response in step S302 and then the second wireless communication unit 120 has received the distance measurement value within a specified time. (S304).

In a case where the second wireless communication unit 120 cannot receive the distance measurement value within the specified time (S304: No), the control unit 130 determines that the distance measurement is not established and causes the first wireless communication unit 110 to transmit a request for re-execution of distance measurement (S306), and the process return to step S304.

On the other hand, in a case where the second wireless communication unit 120 has received the distance measurement value within the specified time (S304: No), the control unit 130 determines whether the distance measurement value is within a specified range (S308).

Here, in a case where the distance measurement value is within the specified range (S308: Yes), the control unit 130 performs control so that a specified operation is executed by the controlled device 30 (S310).

Heretofore, the flow of control performed by the control unit 130 of the vehicle-mounted device 10 according to the present embodiment has been described with an example.

Meanwhile, the above flow described with reference to FIG. 4 is merely an example, and control performed by the control unit 130 according to the present embodiment is not limited to such an example.

For example, it is assumed that the vehicle-mounted device 10 includes a plurality of second wireless communication units 120.

Here, in a case where a condition in which the controlled device 30 is caused to execute the specified operation is specified by a distance between the vehicle-mounted device 10 and the portable device 20, it is only required that distance measurement performed by any of the second wireless communication units 120 is established.

Therefore, in a case where authentication is establish and all the distance measurements between each of the plurality of second wireless communication units 120 and the portable device 20 are not established, the control unit 130 according to the present embodiment may perform control so that the distance measurement between at least one second wireless communication unit 120 and the portable device 20 is re-executed.

On the other hand, in a case where the condition in which the controlled device 30 is caused to execute the specified operation is specified by the coordinate position of the portable device 20, it is required that the distance measurement performed by the plurality of second wireless communication units 120 is established.

Therefore, in a case where the authentication is established and the distance measurement between any of the second wireless communication units 120 and the portable device 20 is not established, the control unit 130 according to the present embodiment may perform control so that the distance measurement between each of the plurality of second wireless communication units 120 and the portable device 20 is re-executed.

The control performed by the control unit 130 according to the present embodiment can be flexibly changed in accordance with the number of second wireless communication units 120, the condition in which the controlled device 30 is caused to execute the specified operation, or the like.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

In addition, a series of processes performed by each device described in the present specification may be realized by a program stored in a non-transitory computer readable storage medium. Each program is read, for example, into a RAM during computer execution and is executed by a processor such as a CPU. The above storage medium is, for example, a magnetic disc, an optical disc, a magneto-optic disc, a flash memory, or the like. In addition, the above program may be distributed, for example, through a network without using a storage medium.

What is claimed is:

1. A wireless communication device, comprising:
a first wireless communication unit configured to transmit and receive a wireless signal compliant with a first communication standard to and from another wireless communication device different from the wireless communication device;
at least one second wireless communication unit configured to transmit and receive a wireless signal compliant with a second communication standard different from the first communication standard to and from the other wireless communication device; and
a control unit configured to control transmission and reception of wireless signals performed by the first wireless communication unit and the second wireless communication unit,
wherein, in a case where authentication based on the wireless signal compliant with the first communication standard is established and specified processing based on the wireless signal compliant with the second communication standard is not established, the control unit performs control so that the authentication is not re-executed and the specified processing is re-executed.

2. The wireless communication device according to claim 1, wherein, in a case where authentication based on the wireless signal compliant with the first communication standard is established and specified processing based on the wireless signal compliant with the second communication standard is not established, the control unit causes the first wireless communication unit to transmit a request for re-execution of the specified processing using the wireless signal compliant with the first communication standard.

3. The wireless communication device according to claim 1, wherein the specified processing includes a process of estimating a positional relationship between the wireless communication device and the other wireless communication device.

4. The wireless communication device according to claim 3, wherein the process of estimating the positional relationship includes distance measurement for estimating a distance between the wireless communication device and the other wireless communication device.

5. The wireless communication device according to claim 4, wherein, in a case where authentication based on the wireless signal compliant with the first communication standard is established and all the distance measurements between each of a plurality of the second wireless communication units and the other wireless communication device are not established, the control unit performs control so that the distance measurement between the at least one second wireless communication unit and the other wireless communication device is re-executed.

6. The wireless communication device according to claim 4, wherein the process of estimating the positional relationship includes a process of estimating position coordinates of the other wireless communication device on the basis of results of a plurality of the distance measurements performed by a plurality of the second wireless communication units.

7. The wireless communication device according to claim 6, wherein, in a case where the authentication based on the wireless signal compliant with the first communication standard is established and distance measurement between any of the second wireless communication units and the other wireless communication device is not established, the control unit performs control so that the distance measurement between each of the plurality of second wireless communication units and the other wireless communication device is re-executed.

8. The wireless communication device according to claim 1, wherein the wireless communication device is mounted in a moving object, and
the other wireless communication device is carried by a user who uses the moving object.

9. The wireless communication device according to claim 8, wherein the control unit controls an operation of a controlled device mounted in the moving object on the basis of a result of the authentication and a result of the specified processing.

10. The wireless communication device according to claim 1, wherein the second communication standard includes ultra-wide band radio.

11. A non-transitory computer readable storage medium having a program stored therein, the program causing a computer to realize a control function of controlling a first wireless communication unit configured to transmit and receive a wireless signal compliant with a first communication standard to and from another wireless communication device and at least one second wireless communication unit configured to transmit and receive a wireless signal compliant with a second communication standard different from the first communication standard to and from the other wireless communication device,
wherein, in a case where authentication based on the wireless signal compliant with the first communication standard is established and specified processing based on the wireless signal compliant with the second communication standard is not established, the control function is caused to perform control so that the authentication is not re-executed and the specified processing is re-executed.

12. A system comprising:
a first wireless communication device; and
a second wireless communication device,
wherein the first wireless communication device includes
a first wireless communication unit configured to transmit and receive a wireless signal compliant with a first communication standard to and from the second wireless communication device,
at least one second wireless communication unit configured to transmit and receive a wireless signal compliant with a second communication standard different from the first communication standard to and from the second wireless communication device, and
a control unit configured to control transmission and reception of wireless signals performed by the first wireless communication unit and the second wireless communication unit,
wherein, in a case where authentication based on the wireless signal compliant with the first communication standard is established and specified processing based on the wireless signal compliant with the second communication standard is not established, the control unit performs control so that the authentication is not re-executed and the specified processing is re-executed.
